(19) United States
(12) Patent Application Publication
(10) Pub. No.: US 2019/0052597 A1
(43) Pub. Date: Feb. 14, 2019

(54) OPTIMIZING CHOICE OF NETWORKING PROTOCOL

(71) Applicant: salesforce.com, inc., San Francisco, CA (US)

(72) Inventors: Satish Raghunath, Sunnyvale, CA (US); Kartikeya Chandrayana, San Francisco, CA (US); Shauli Gal, Mountain View, CA (US)

(21) Appl. No.: 15/674,945

(22) Filed: Aug. 11, 2017

(51) Int. Cl. H04L 29/12; H04L 12/24; G06N 99/00

(52) U.S. Cl. CPC H04L 61/2007; H04L 61/1511; H04L 67/42; G06N 99/005; H04L 61/6059; H04L 41/0893

(57) ABSTRACT

Network performance data metrics are gathered and aggregated. A policy engine chooses an optimal selection of networking protocol based on the metrics. Data delivery strategies are applied to a portion of a network to deliver content using the received choice of networking protocol policy optimized by machine learning techniques.

### TECHNOLOGY

The present invention relates generally to analysis of network performance data, and in particular, to optimization of networking protocol choice.

### BACKGROUND

Cellular networks are very volatile and diverse. Due to the nature of the wireless channel, link conditions change at a fine timescale. Metrics such as latency, jitter, throughput, and losses are hard to bound or predict. The diversity comes from the various network technologies, plethora of devices, platforms, and operating systems in use.

Techniques that rely on compression or right-sizing content do not address the fundamental issues of network volatility and diversity as they impact the transport of data. Irrespective of the savings in compression, the data still has to weather the vagaries of the network, operating environment, and end device.

Internet Protocol (IP) plays an important role in the content delivery business: it tells every content consumer a set of rules governing the format of data sent over the network or Internet to download content. Typically, network latency is thought to be related to geographic distance, such that the closer geographically two points are, the lower the expected network latency. However, due to various reasons, such as agreements between operators on how traffic is routed among their networks, choice of IP, business incentives, politics, and even human errors may lead to unexpected network latencies.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section. Similarly, issues identified with respect to one or more approaches should not assume to have been recognized in any prior art on the basis of this section, unless otherwise indicated.

### BRIEF DESCRIPTION OF DRAWINGS

The present invention is illustrated by way of example, and not by way of limitation, in the figures of the accompanying drawings and in which like reference numerals refer to similar elements and in which:

FIG. 1 illustrates a high-level block diagram, according to an embodiment of the invention;

FIG. 2 illustrates a high-level block diagram, including an example protocol selector according to an embodiment of the invention;

FIG. 3 illustrates a high-level interaction flow diagram of optimization of networking protocol choice, according to an embodiment of the invention;

FIG. 4 illustrates a flowchart for optimization of networking protocol choice, according to an embodiment of the invention; and

FIG. 5 illustrates an example hardware platform on which a computer or a computing device as described herein may be implemented.

### DESCRIPTION OF EXAMPLE EMBODIMENTS

Example embodiments, which relate to optimizing networking protocol choice, are described herein. In the following description, for the purposes of explanation, numerous specific details are set forth in order to provide a thorough understanding of the present invention. It will be apparent, however, that the present invention may be practiced without these specific details. In other instances, well-known structures and devices are not described in exhaustive detail, in order to avoid unnecessarily occluding, obscuring, or obfuscating the present invention.

Example embodiments are described herein according to the following outline:
1. GENERAL OVERVIEW
2. VERSIONING NETWORKING PROTOCOLS
3. OPTIMIZATION OF NETWORKING PROTOCOL CHOICE
4. PROMULGATING POLICY OF NETWORKING PROTOCOL CHOICE
5. IMPLEMENTATION MECHANISMS—HARDWARE OVERVIEW
6. EQUIVALENTS, EXTENSIONS, ALTERNATIVES AND MISCELLANEOUS

### 1. GENERAL OVERVIEW

This overview presents a basic description of some aspects of an embodiment of the present invention. It should be noted that this overview is not an extensive or exhaustive summary of aspects of the embodiment. Moreover, it should be noted that this overview is not intended to be understood as identifying any particularly significant aspects or elements of the embodiment, nor as delineating any scope of the embodiment in particular, nor the invention in general. This overview merely presents some concepts that relate to the example embodiment in a condensed and simplified format, and should be understood as merely a conceptual prelude to a more detailed description of example embodiments that follows below.

Modern data transport networks feature a huge variety of network technologies, end-user devices, and software. Some of the common network technologies include cellular networks (e.g., LTE, HSPA, 3G, 4G, and other technologies), WiFi (e.g., 802.11xx series of standards), satellite, and microwave. In terms of devices and software, there are smartphones, tablets, personal computers, network-connected appliances, electronics, etc., that rely on a range of embedded software systems such as Apple iOS, Google Android, Linux, and several other specialized operating systems. There are certain shared characteristics that impact data delivery performance:
a. Many of these network technologies feature a volatile wireless last mile. The volatility manifests itself in the application layer in the form of variable bandwidth, latency, jitter, loss rates and other network related impairments.
b. The diversity in devices, operating system software and form factors results in a unique challenge from the perspective of user experience.
c. The nature of content that is generated and consumed on these devices is quite different from what was observed with devices on the wired Internet. The new content is very dynamic and personalized (e.g., adapted to location, end-user, other context sensitive parameters, etc.).

A consequence of these characteristics is that end-users and applications running on devices experience inconsistent and poor performance. This is because most of the network mechanisms today are not equipped to tackle this new nature of the problem. In terms of the transport, today's client and server software systems are best deployed in a stable operating environment where operational parameters either change a little or do not change at all. When such software systems see unusual network feedback they tend to over-react in terms of remedies. From the perspective of infrastructure elements in the network that are entrusted with optimizations, current techniques like caching, right sizing, and compression fail to deliver the expected gains. The dynamic and personalized nature of traffic leads to low cache hit-rates and encrypted traffic streams that carry personalized data make content modification much harder and more expensive.

Modern heterogeneous networks feature unique challenges that are not addressed by technologies today. Unlike the wired Internet where there was a stable operating environment and predictable end device characteristics, modern heterogeneous networks require a new approach to optimize tasks such as data delivery. Within the Internet, an autonomous system (AS) is a collection of connected Internet Protocol (IP) routing prefixes under the control of one or more network operators on behalf of a single administrative entity or domain that presents a common, clearly defined routing policy to the Internet. Machine learning techniques may be used to choose an optimal version of IP, such as IP version 4 (IPv4) or IP version 6 (IPv6) based on various characteristics of an endpoint's operating context. DNS and other cloud servers may use the client's source IP address to tell which administrative network the client is coming from. The Authoritative DNS server may allow the matching of clients using an optimally chosen version of IP to a specific DNS response. This DNS feature may be exposed via an application programming interface (API), in one embodiment.

Various modifications to the preferred embodiments and the generic principles and features described herein will be readily apparent to those skilled in the art. Thus, the disclosure is not intended to be limited to the embodiments shown, but is to be accorded the widest scope consistent with the principles and features described herein.

### 2. VERSIONING NETWORKING PROTOCOLS

Internet endpoints, or end-devices, may choose between two main versions of Internet Protocol, IPv4 and IPv6. An Internet Protocol describes a set of formatting rules that have been adopted by standards bodies to relay information of networks. IPv4 may provide a format of 172.16.254.1, dotted decimal notation (which translates to 10101100.00010000.11111110.00000001), where the 32-bit addressing provides approximately 4.3 billion addresses. In contrast, IPv6 may provide a format of 2017:0AB8:F810:1981:0000:0000:0000:0000, in hexadecimal, where the 128-bit addressing provides, theoretically, 2̂128 or 3.4×10̂38 addresses. The different versions of networking protocols addresses the issue of address scarcity—as more end-devices are connected to a network, each end-device may be assigned an IP address. End-devices may include any Internet-enabled devices, such as laptops, mobile devices, smart watches, wearable devices, refrigerators, lightbulbs, parking meters, point of sale (POS) devices, near-field communication devices, airplane engines, and so forth. This “Internet of Things” (IoT) phenomenon describes the proliferation of Internet-enabled devices that report data about machines at an unprecedented scale. Thus, the performance of data delivery is closely tied to the operating conditions within which the end-device is operating. With ubiquitous wireless access over cellular and WiFi networks, there is a lot of volatility in operating conditions, so acceleration techniques may be used to adapt to such a network by adapting to these conditions, e.g., the performance achievable over a private WiFi hotspot is very different from that with a cellular data connection. An accelerator dynamically adapts to these conditions and picks the best strategies based on the context. An accelerator sits in the path of the data traffic and executes recommended strategies in addition to gathering and measuring network related information in real-time. In one embodiment, an accelerator may be a proxy host that is geographically distributed.

The context captures the information about the operating conditions in which data transfer requests are being made. This includes, but is not limited to, any combination of:
Type of device, e.g., iPhone, iPad, Blackberry, etc.
   This may also include the version of the device and manufacturer information.
Device characteristics, e.g., the type of its modem, CPU/GPU, encryption hardware, battery, NFC (Near Field Communication) chipset, memory size and type or any other hardware information that impacts performance
Mobility of device, e.g., whether the device is on a moving vehicle/train etc., or is stationary/semi-stationary.
Operating System on the device.
Operating System characteristics, e.g., buffering, timers, public and hidden operating system facilities (APIs), etc.
   This may also include operating system limitations such as number of simultaneous connections allowed to a single domain, etc.
Usage information related to various device elements, e.g., Memory, Storage, CPU/GPU etc.
Battery charge and mode of powering the device.
Time of day.
Location where available.
IP Address and port numbers.
Network type, e.g., WiFi or Cellular, or 3G/4G/LTE, etc., or Public/Home WiFi, etc.
   SSID (Service Set Identifier) in WiFi networks.
   802.11 network type for WiFi networks.
Service Provider information, e.g., AT&T or Verizon for cellular, Time Warner or Comcast for WiFi, etc.
Strength of signal from the access point (e.g., Wi-Fi hot spot, cellular tower, etc.) for both upstream and downstream direction.
Cell-Tower or Hot-Spot identifier in any form.
Number of sectors in the cell tower or hot spot.
Spectrum allocated to each cell tower and/or sector.
Any software or hardware limitation placed on the hot-spot/cell tower.
Any information on the network elements in the path of traffic from device to the content server.
Firewall Policy rules, if available.
Any active measurements on the device, e.g., techniques that measure one-way delay between web-server and device, bandwidth, jitter, etc.
Medium of request, e.g., native app, hybrid app, web-browser, etc.
   Other information describing the medium, e.g., web browser type (e.g., Safari, Chrome, Firefox etc.), application name, etc.
Any other third party software that is installed on the device which impacts data delivery performance.
Content Type, e.g., image, video, text, email, etc.
   Also includes the nature of content if it is dynamic or static.
Content Location, e.g., coming from origin server or being served from a CDN (Content Delivery Network).
   In the case of a CDN, any optimization strategies being employed, if available.
Recent device performance statistics, e.g., dropped packets, bytes transferred, connections initiated, persistent/on-going connections, active memory, hard disk space available, etc.
Caching strategies if any, that are available or in use on the device or by the application requesting the content.
In the case of content, where multiple objects have to be fetched to completely display the content, the order in which requests are placed and the order in which objects are delivered to the device. The request method for each of these objects is also of interest.

Based on the operating context, a cognitive engine may be able to recommend, but is not limited to, any combination of: end-device based data delivery strategies and/or accelerator-based data delivery strategies.

End-device based data delivery strategies refer to methods deployed by an application (an application could be natively running on the end-device operating system, or running in some form of a hybrid or embedded environment, e.g., within a browser, etc.) to request, receive or, transmit data over the network. These data delivery strategies include, but are not limited to, any combination of:
Methods used to query the location of service point, e.g., DNS, etc.
   This may involve strategies that include, but are not limited to, any combination of: choosing the best DNS servers based on response times, DNS prefetching, DNS refreshing/caching, etc.
Protocols available for data transport, e.g., UDP, TCP, SCTP, RDP, ROHC, etc.
Methods to request or send data as provided by the operating system, e.g., sockets, CFHTTP or NSURLConnection in Apple's iOS, HttpUrlConnection in Google's Android, etc.
Session oriented protocols available for requests, e.g., HTTP, HTTPS, FTP, RTP, Telnet, etc.
Full duplex communication over data transport protocols, e.g., SPDY, Websockets, etc.
Caching and or storage support provided in the Operating System.
Compression, right sizing or other support in the devices to help reduce size of data communication.
Transaction priorities which outline the order in which network transactions to be completed:
   E.g., this may be a list of transactions where the priority scheme is simply a random ordering of objects to be downloaded.
Content specific data delivery mechanisms, e.g., HTTP Live Streaming, DASH, Multicast, etc.
Encryption support in the device:
   Also includes secure transport mechanisms, e.g., SSL, TLS, etc.
VPN (Virtual Private Network) of any kind where available and/or configured on the device.
Any tunneling protocol support available or in use on the device.
Ability to use or influence rules on the device which dictate how the data needs to be accessed or requested or delivered.
   This includes, but is not limited to, any combination of: firewall rules, policies configured to reduce data usage, etc.
Ability to pick the radio technology to use to get/send data. For example, if allowed, the ability to choose cellular network to get some data instead of using a public Wi-Fi network.
Ability to run data requests or process data in the background.
Threading, locking, and queuing support in the Operating System.
Ability to modify radio power if available.
Presence and/or availability of any error correction scheme in the device.
In cases where middle boxes in the network infrastructure have adverse impact on performance, capabilities on the end-device to deploy mitigations such as encrypted network layer streams (e.g. IPSec, etc.).

A range of parameters determines the performance of tasks such as data delivery. With volatility and diversity, there is an explosion in the number of parameters that may be significant. By isolating parameters, significant acceleration of data delivery may be achieved. Networks, devices and content are constantly changing. Various methods of optimizing data delivery are described in U.S. patent application Ser. No. 14/078,481, entitled “Cognitive Data Delivery Optimizing System,” filed Nov. 12, 2013, issued on Jan. 10, 2017 as U.S. Pat. No. 9,544,205 and which is hereby incorporated by reference in its entirety for all purposes. Embodiments are not tied down by assumptions on the current nature of the system. One aspect of data delivery that may be optimized is choice of networking protocol.

There may be many reasons for an Internet endpoint to choose IPv4, including the ability to communicate with IPv4-only services without having to go through IPv6-IPv4 translation, the existence of IPv4 only networks where there is no other choice, and legacy client software that makes assumptions only valid using IPv4, such as programming code that handles addresses as integers. One of the primary drivers of IPv6 adoption, however, is the lack of IPv4 addresses. In emerging countries, many IP addresses using the IPv4 version have been assigned. Further, the number of IoT devices has exploded, necessitating the move to IPv6. As mentioned above, IPv6 has a much larger addressing space. Network Address Translation (NAT), which causes a performance hit or a perceivable network performance degradation, may be avoided when a global IPv4 address is unavailable. Furthermore, IPv6 enables a group addressing scheme using Autonomous System Numbers (ASNs). While the ability to choose a common prefix for the AS may have been previously available for IPv4, this assumes that such a prefix is available to be assigned. With IPv6, additional addresses are available for group addressing. Using ASNs enables large groups of smaller devices on a network, such as wearable devices, coffee makers, or air conditioning units, to be grouped under a unique ASN.

The Internet is currently in a transitory phase in which a large amount of network traffic is still using IPv4. Differences in performance may be experienced by endpoints between the two revisions, or versions, of networking protocols. Whether one version performs better than the other depends on one or more factors, such as endpoint operating system (OS) performance and/or support for IPv6, endpoint application (app) performance and/or support for IPv6, access network configuration, server OS performance and/or support for IPv6, and/or server app performance and/or support for IPv6. Additionally, the choice of IP policy may enable network administrators and/or administrators of the protocol selector to group performance by IP protocol. Dumb machines that transact on small files generally (e.g., less than 5K) may not require lightning fast transfer speeds, whereas mobile phones and applications operating on the phones may require higher bandwidth and throughput parameters. Different IP protocol choices may be made accordingly as a matter of policy.

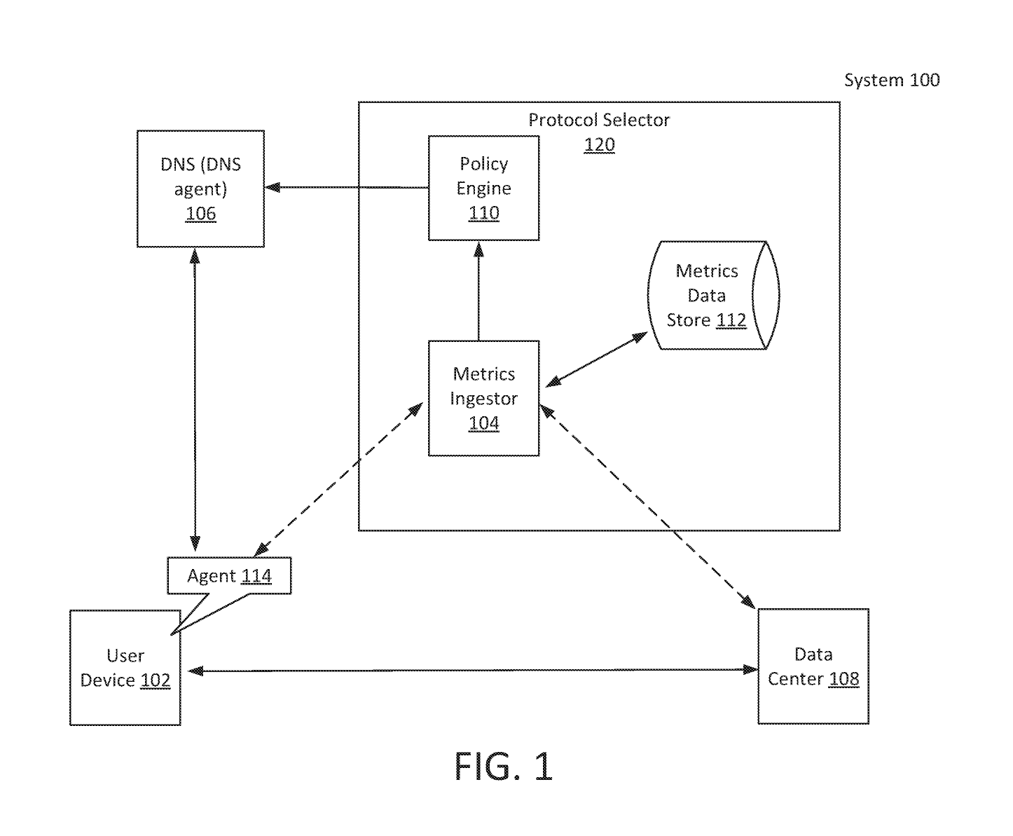

FIG. 1 and the other figures use like reference numerals to identify like elements. A letter after a reference numeral, such as “102a,” indicates that the text refers specifically to the element having that particular reference numeral. A reference numeral in the text without a following letter, such as “102,” refers to any or all of the elements in the figures bearing that reference numeral (e.g. “102” in the text refers to reference numerals “102a,” and/or “102b” in the figures). Only one user device 102 (end-devices or endpoints as described here) are shown in FIG. 1 in order to simplify and clarify the description.

As illustrated in FIG. 1, a system 100 includes a user device 102 may request and receive information from a data center 108 over a network. Various elements of the system 100 are not illustrated, such as the accelerator described above that may be embodied as a proxy host server in geographic proximity to the data center 108, for simplicity and clarity in the description.

In an embodiment, a component may be installed in the user device 102 (agent 114) that provides inputs about the real-time operating conditions, participates and performs active network measurements, and executes recommended strategies. The agent 114 may be supplied in a software development kit (SDK) and is installed on the user device 102 when an application that includes the SDK is installed on the user device 102. By inserting an agent 114 in the user device 102 to report the observed networking conditions back to the accelerator, estimates about the state of the network can be vastly improved. The main benefits of having a presence (the agent 114) on the user device 102 include the ability to perform measurements that characterize one leg of the session, e.g., measuring just the client-to-server leg, etc. In another embodiment, no software development kit (SDK) is involved. In that embodiment, device software such as a browser can instrument HTTP headers with relevant headers that provide a similar infrastructure that the SDK collects. As long as there is a source of such information, such an embodiment can accomplish the same or a substantially similar optimization.

A data center 108 and the agent 114 may provide various metrics, or measurements, of data related to network transaction with user devices 102 to a metrics ingestor 104 within a protocol selector 120. These data metrics ingested by the metrics ingestor 104 may then be stored in a metrics data store 112.

Each database record in the metrics data store 112 may include a domain name, data center name, timestamp, and measured latency, or data round-trip time (RTT) value. Other information may also be included in each database record, in other embodiments. Typical sources of data relating to the network environment are elements in the network infrastructure that gather statistics about transit traffic and user devices that connect to the network as clients or servers. The data that can be gathered includes, but is not limited to, any combination of: data pertaining to requests for objects, periodic monitoring of network elements (which may include inputs from external source as well as results from active probing), exceptional events (e.g., unpredictable, rare occurrences, etc.), data pertaining to the devices originating or servicing requests, data pertaining to the applications associated with the requests, data associated with the networking stack on any of the devices/elements that are in the path of the request or available from any external source, etc.

The protocol selector 120 may also include a policy engine 110 that applies machine learning techniques to select a version of networking protocol given the metrics ingested and stored in the metrics data store 112. For example, an endpoint, or user device 102, may be a coffee machine that communicates a message to a data center 108 when the coffee machine is broken and needs repair. The data metrics ingested by the metrics ingestor 104 may include a description of the coffee machine, a serial number associated with the machine, a make and model number of the machine, and so on. The data metrics may be provided by the data center 108 that may access various data stores to provide additional information about the user device 102. The user device 102 may only have a simple functionality to communicate a simple message that includes a user device identifying information, or a user identifier (UID) and an error code, for example. An agent 114 at the user device 102 may communicate additional information to the metrics ingestor 104, such as the type of network accessible by the user device 102, network transaction metrics such as RTT, download time for first byte of transfer, and so forth.

Based on the metrics from the metrics ingestor 104, a policy engine 110 may optimally choose a version of IP, such as IPv4 or IPv6. This policy choice may be determined using machine learning techniques, including heuristics, training set data that achieves desired outcomes, regression analysis, Monte Carlo simulations, and other known machine learning methods. A policy may be promulgated to a DNS (DNS agent) 106 and/or to the agent 114. In this way, the user device 102 may optimally choose a networking protocol version, or revision, that provides an outcome of perceivably higher network performance given the constraints and/or circumstances of the network transactions involved with the data center 108.

### 3. OPTIMIZATION OF NETWORKING PROTOCOL CHOICE

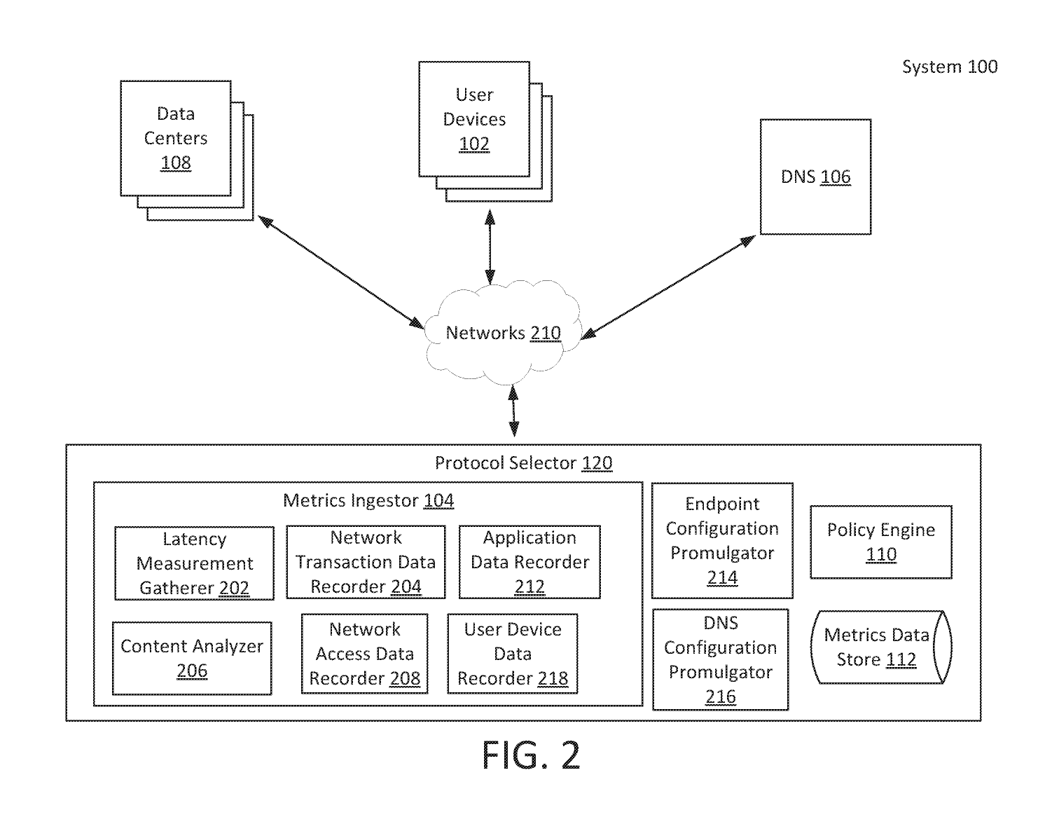

FIG. 2 illustrates a high-level block diagram, including an example protocol selector, according to an embodiment. A protocol selector 120 may include a metrics ingestor 104 that further may include a latency measurement gatherer 202, a network transaction data recorder 204, a content analyzer 206, a network access data recorder 208, a user device data recorder 218, and an application data recorder 212. The protocol selector may also include an endpoint configuration promulgator 214, a DNS configuration promulgator 216, a policy engine 110 and a metrics data store 112, in one embodiment. The protocol selector 120 may communicate data over one or more networks 210 with other elements of system 100, such as user devices 102, one or more DNS servers 106, and data centers 108.

A latency measurement gatherer 202 reads and/or determines, from a metrics data store 112, one or more latency measurement values for combinations of user devices 102 and data centers 108. In one embodiment, a latency, or RTT value, is measured by an agent 114 of a user device 102. The latency measurement gatherer 202 captures the RTT value measured by the agent 114 through an API call, in an embodiment. In one example, an aggregated value of RTT values may be used as a latency measurement. In another example, a different aggregation of RTT values may be used instead of an average of measured RTT values, such as a percentile (e.g., 75^{th} percentile) or a range of percentiles of a distribution of the measured RTT values. An average may be too sensitive to outliers and administrators may select from different types of aggregations. Various types of aggregations may be used based on statistical methods.

A network transaction data recorder 204, in one embodiment, records data associated with a network transaction as well as measurements about the data transferred between a user device 102 and a data center 108. Various types of information may be recorded, such as the access network configuration, Uniform Resource Locator (URL) that was accessed, size of the content that was downloaded, time to first byte, time to complete the download, content type and encoding, and content source IP address.

A content analyzer 206, in one embodiment, analyzes the type of content being transferred. For example, a size of content (e.g., in kilobytes (KB)), a quality of content (message, compressed content such as MP3/MP4/MPG, streaming content, encrypted content, and so on), a format of content, metadata attached to the content, header file information, and/or other qualitative characteristics of content may be determined by a content analyzer 206.

A network access data recorder 208, records information used to access a network. Network access control (NAC) is a networking solution that uses a set of protocols to set and define a policy that describes how to secure access to network nodes by devices when they initially try to access a network. A basic form of NAC is the 802.1X standard. A NAC system implements a policy that ensures that an endpoint may only access various parts of the network, including pre-admission endpoint security policy checks and post-admission controls over where users and devices can access data on the network and what they can do (e.g., read, write, delete, encrypt, decrypt, copy, duplicate, and other functionality associated with data).

A user device data recorder 218, in one embodiment, records data associated with an endpoint or user device 102. For example, an operating context that describes the details of the endpoint may be recorded, such as hardware make and model, operating system revision, network access technology, network operator name, IP address, and application identifier and version.

An application data recorder 212, in one embodiment, records data associated with an application that may not be accessible to a user. For example, configuration files, operating files, library data, and log files may be application data that could be recorded by the application data recorder 212. Any other type of information that may be gathered or recorded about the application by the agent 114 operating on the user device 102 is recorded by the application data recorder 212.

The protocol selector may also include an endpoint configuration promulgator 214 and/or a DNS configuration promulgator 216. An endpoint configuration promulgator 214 causes an endpoint, or a user device 102, to receive an optimally chosen policy of using a particular version of IP, such as IPv4, IPv6, etc., by the policy engine 110. The endpoint configuration promulgator 214 communicates the policy to the agent 114 which then is instructed to implement the policy at the user device 102.

A DNS configuration promulgator 216 is used to configure a DNS 106 to implement the optimally chosen policy based on the various parameters interpreted by the policy engine 110. If the DNS 106 has the parameters to implement the chosen policy, then the DNS configuration promulgator 216 will communicate instructions to the DNS agent to implement the policy on the DNS 106.

The cyclical nature of the process mitigates the reality of changes in operating contexts. Because network conditions are constantly changing, new metrics may be received from agents 114 that causes the protocol selector 120 to choose a different policy. Because the policy is delivered via an application programming interface (API), the endpoint configuration promulgator 214 or the DNS configuration promulgator 216 quickly promulgates a new policy by changing the API parameters. In this way, an API wraparound, or wrapper, enables the policy to be pushed or promulgated to a DNS agent 106 or the agent 114 operating on the user device 102 to implement the change in policy, in an embodiment. An API manager (not illustrated) may manage one or more APIs used to control the DNS 106. For example, a particular DNS may be controlled using a particular API whereas a different DNS may be controlled with a different API. As new APIs become available, the API manager may be updated to enable the protocol selector 120 to send new instructions to the DNS 106 or agent 114.

In an embodiment, an operating context may be defined in terms of a fixed set of attributes of a mobile session such as the location, time-of-day, device type, and software platform on the device. For each such operating context, the impact of strategies on performance may be measured as the values of certain representative metrics such as round trip latency, throughput, loss rates, and jitter. Thus, the metrics data store 112 includes bucketed operating context vectors along with measured results for performance strategies applied in those contexts. Such a data store 112 is queried to track the empirically measured performance for various operating contexts. The underlying assumption is a reasonable stationarity in metrics tracked. The data associated with each operating context has an expiry time after which it is discarded. New inputs for the same operating context are accumulated by way of aggregate statistics of each interesting metric. An operating context is associated with results for specific performance strategies in order to facilitate self-learning. A protocol selector 120 generates programmable logic to insert into a DNS server 106 via an API. The API takes into account the characteristics of the network as stored in the metrics data store 112.

### 4. PROMULGATING POLICY OF NETWORKING PROTOCOL CHOICE

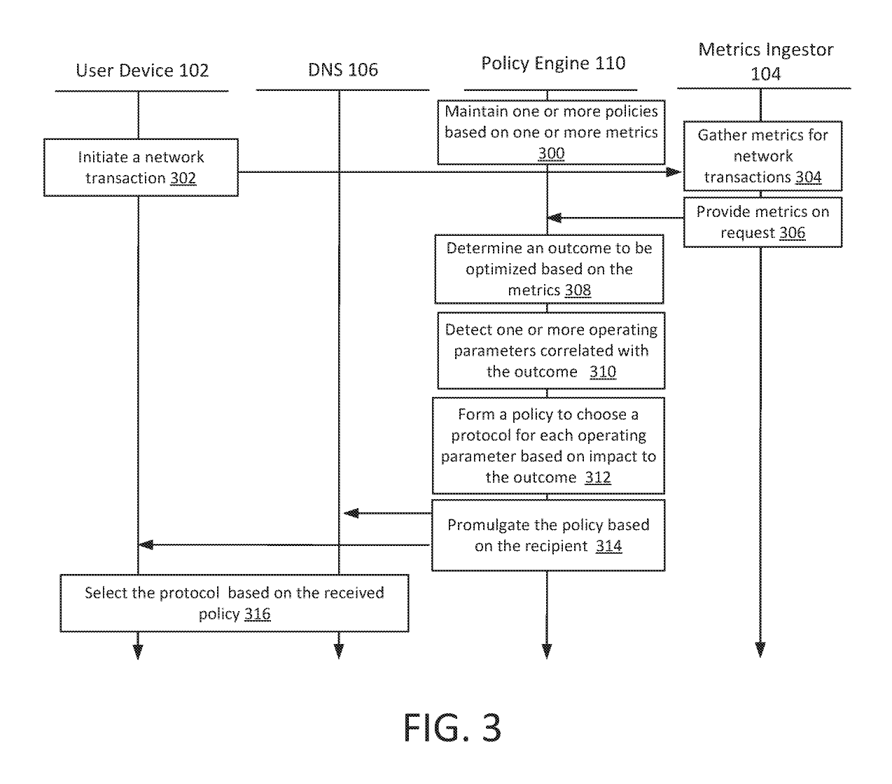

FIG. 3 illustrates a high-level interaction diagram of optimization of networking protocol choice, according to an embodiment. One or more policies are maintained 300 by a policy engine 110 based on one or more metrics in a metrics data store 112. A network transaction may be initiated 302 at a user device 102. A metrics ingestor 104 gathers 304 metrics for network transactions. Later, metrics are provided 306 on request to the policy engine 110. For example, a request is made by the policy engine 110 for metrics from the metrics ingestor 104 upon first generating a policy choice of protocol. In another embodiment, a request is made by the policy engine 110 automatically over time, periodically, to account for changes in the network, changes in operating conditions at the client and/or DNS, and so forth. In a further embodiment, metrics are provided 306 on request to the policy engine 110 based on a request from an administrator user of the system.

An outcome is determined 308 to be optimized based on the metrics by the policy engine 110. One or more operating parameters are detected 310 by the policy engine 110 to be correlated with the optimized outcome. A policy is then formed 312 to choose a protocol for each operating parameter based on an impact to the outcome. The policy is then promulgated 314 to the recipient. The recipient may be the DNS 106 or the endpoint or user device 102. Based on the received policy, a networking protocol is selected 316.

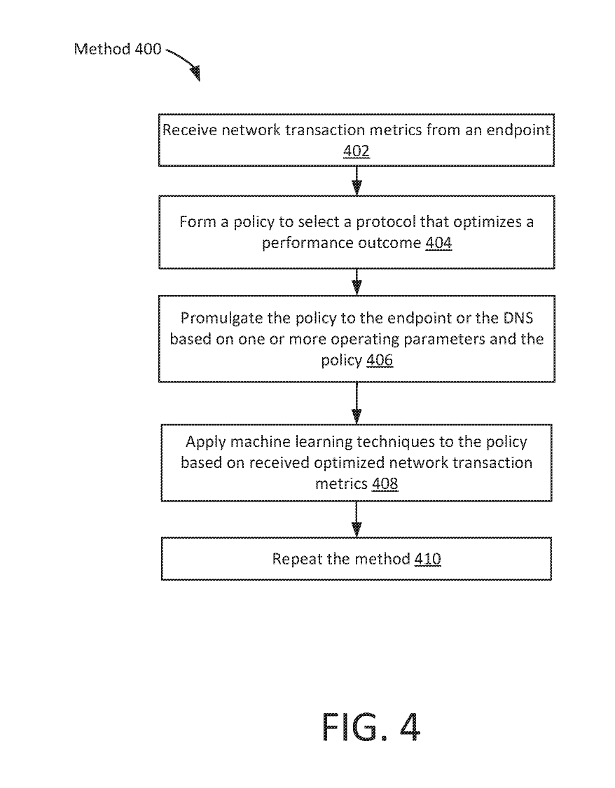

FIG. 4 illustrates a flowchart for optimization of networking protocol choice, according to an embodiment of the invention. Method 400 may be used to automate the optimization of networking protocol choice, in an embodiment. Network transaction metrics may be received 402 from an endpoint or data center. For example, the time to first byte downloaded may be captured, or ingested, by the metrics ingestor 104 and stored in the metrics data store 112. A diversity of metrics may also be captured in the same network transaction from one or both of the agent 114 and the data center 108 and stored in the metrics data store 112, such as the hardware make and model of the user device 102, the quality of network access (e.g., WiFi, 3G, 4G, LTE, firewalls, routers, etc.), content analysis data (e.g., file size, email message, SMTP packaging, JPEG file attachment, etc.), application data associated with the user device 102 and/or agent 114, among other types of information stored in the metrics data store 112. A policy is formed 404 to select a protocol that optimizes a performance outcome. In one embodiment, a policy to select IPv6 as the networking protocol choice may depend on operating parameters at the endpoint to access a network via WiFi, have a file size of less than 600 KB, and user device information indicating the user device 102 is a mobile device that has support and/or performance optimization for IPv6 networking protocol. Various combinations of metrics may be defined as policies or formed 404 by an administrator of the protocol selector 120 or by machine learning techniques.

In some embodiments, various techniques may be used to choose where the policy will be received, such as being client-driven or DNS-driven. A client-driven choice results in the endpoint resolving a name that yields A records (if the choice was IPv4) or AAAA records (if the choice was IPv6). For example, for user devices 102 running OS version 2.1, requests bound for “domain.com” would resolve instead to “v4.domain.com” based on the choice being made for IPv4. In this client-driven scenario, the client uploads the operating context. In response, the client receives the name that needs to be resolved to access the service. If the policy engine determined that this operating context is better served by an IPv4 endpoint, this response could contain ‘v4.domain.com’ as the name. If not, it could contain ‘v6.domain.com’. In parallel, the DNS is programmed such that ‘v4.domain.com’ results in IPv4 address answers while ‘v6.domain.com’ results in IPv6 answers. The client then resolves the appropriate name. Similarly, a DNS-driven choice results in the DNS agent at the DNS 106 to map the relevant name resolution entries to A records (if the choice was IPv4) or AAAA (if the choice was IPv6) with filters to make the choice as per the policy. Some examples may include: for endpoints from IPv4 prefix 1.2.3.0/24, the answers will be A records a1, a2; for endpoints from Autonomous System number 12000, the answers will be AAAA records qa1, qa2.

Then, the policy may be promulgated 406 to the endpoint or to the DNS based on one or more operating parameters and the policy. The promulgation of the policy is described above throughout and further described with respect to FIG. 3.

Machine learning techniques may then be applied 408 to the policy based on received optimized network transaction metrics. Data classification techniques that use training data sets to determine optimal parameters for a particular outcome, such as reduction in latency and/or perceived network performance improvement, may be implemented or applied 408 here to the policy formed 404 above.

The method 400 may then be repeated 410. This may be repeated in an ongoing manner, periodically (e.g., after a set period of time has elapsed), repeated a determined number of times (e.g., repeat one hundred times), or any combination of the above.

Characteristics of modern networks change at a very rapid clip. The diversity of devices, content, device types, access mediums, etc., further compound the volatility of the networks. These facets make the problem hard to characterize, estimate or constrain resulting in inefficient, slow and unpredictable delivery of any content over these networks. However, there is a large amount of information about the network available in the transit traffic itself—from billions of devices consuming data. Each of the network metrics data affect a portion of the system performance, whether that is client performance, access network performance, or server performance. Because the method 400 optimizes a choice of Internet Protocol (IP), addressing a problem that is having a measurable impact on system performance that exceeds a baseline, the system is able to provide one or more reliable recommendations to improve a portion of the system (client, network, and/or server side) that will improve overall network performance as perceived by users. The optimized choice of IP may be automatically generated by the method 400 using a rules-based engine, expert-entered baselines, automatically generated baselines, and/or impact assessment metrics based on regression analysis using data stored in the metrics data store 112. As a result, the system has improved its own performance by using metrics data that covers app performance, user device performance, network performance, and server performance. Using that metrics data, data analysis is generated to point to specific areas of the system that can be improved and a concrete assessment of the impact of that improvement will have on the overall performance of the system. By efficiently calculating and determining such improvements, the system continuously collects information across the network that allows for more precise efficiency recommendations or network changes, over time. This information that describes network operating characteristics and defines efficacy of data delivery strategies is called a “network imprint”. The approaches described herein allow embodiments to compute this network imprint. Embodiments include an apparatus comprising a processor and configured to perform any one of the foregoing methods. Embodiments include a computer readable storage medium, storing software instructions, which when executed by one or more processors cause performance of any one of the foregoing methods. Note that, although separate embodiments are discussed herein, any combination of embodiments and/or partial embodiments discussed herein may be combined to form further embodiments.

### 5. IMPLEMENTATION MECHANISMS—HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

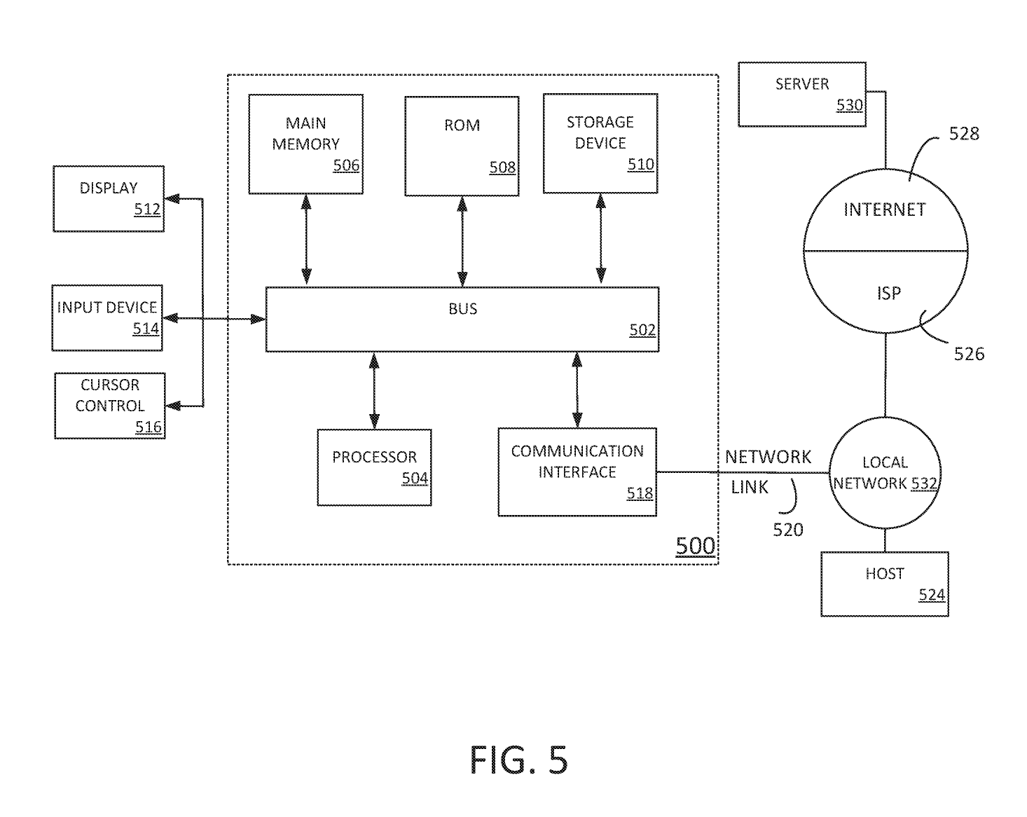

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is device-specific to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a liquid crystal display (LCD), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using device-specific hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 6. EQUIVALENTS, EXTENSIONS, ALTERNATIVES AND MISCELLANEOUS

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method, comprising:
determining an operating context at a client;
sending the operating context to a policy engine;
receiving at an agent a choice of Internet Protocol (IP) policy associated with the client based on the operating context from the policy engine;
configuring the agent based on the choice of IP policy,
wherein responsive to the agent receiving a data request, the agent applying the choice of IP policy to the data request.

2. The method as recited in claim 1, wherein an operating context comprises one or more network transaction metrics.

3. The method as recited in claim 2, wherein a client-side subset of the one or more network transaction metrics is gathered from a client-side agent operating on the client.

4. The method as recited in claim 2, wherein a server-side subset of the one or more network transaction metrics is gathered from a data center associated with the data request.

5. The method as recited in claim 1, further comprising applying a machine learning-based optimization process to the choice of IP policy to produce a new outcome.

6. The method as recited in claim 5, further comprising repeating the applying the machine learning-based optimization process to the choice of IP policy until the new outcome reaches a predetermined threshold of impact.

7. A non-transitory computer readable medium storing a program of instructions that is executable by a device to perform a method, the method comprising:
determining an operating context at a client;
sending the operating context to a policy engine;
receiving at an agent a choice of Internet Protocol (IP) policy associated with the client based on the operating context from the policy engine;
configuring the agent based on the choice of IP policy,
wherein responsive to the agent receiving a data request, the agent applying the choice of IP policy to the data request.

8. The non-transitory computer readable medium as recited in claim 7, wherein an operating context comprises one or more network transaction metrics.

9. The non-transitory computer readable medium as recited in claim 8, wherein a client-side subset of the one or more network transaction metrics is gathered from a client-side agent operating on the client.

10. The non-transitory computer readable medium as recited in claim 8, wherein a server-side subset of the one or more network transaction metrics is gathered from a data center associated with the data request.

11. The non-transitory computer readable medium as recited in claim 7, further comprising applying a machine learning-based optimization process to the choice of IP policy to produce a new outcome.

12. The non-transitory computer readable medium as recited in claim 11, further comprising repeating the applying the machine learning-based optimization process to the choice of IP policy until the new outcome reaches a predetermined threshold of impact.

13. An apparatus, comprising:
a subsystem, implemented at least partially in hardware, that determines an operating context at a client;
a subsystem, implemented at least partially in hardware, that sends the operating context to a policy engine;
a subsystem, implemented at least partially in hardware, that receives at an agent a choice of Internet Protocol (IP) policy associated with the client based on the operating context from the policy engine;
a subsystem, implemented at least partially in hardware, that configures the agent based on the choice of IP policy, wherein responsive to the agent receiving a data request, the agent applying the choice of IP policy to the data request.

14. The apparatus as recited in claim 13, wherein an operating context comprises one or more network transaction metrics.

15. The apparatus as recited in claim 14, wherein a client-side subset of the one or more network transaction metrics is gathered from a client-side agent operating on the client.

16. The apparatus as recited in claim 14, wherein a server-side subset of the one or more network transaction metrics is gathered from a data center associated with the data request.

17. The apparatus as recited in claim 13, further comprising a subsystem, implemented at least partially in hardware, that applies a machine learning-based optimization process to the choice of IP policy to produce a new outcome.

18. The apparatus as recited in claim 17, further comprising a subsystem, implemented at least partially in hardware, that repeats functioning of the applying subsystem that applies the machine learning-based optimization process to the choice of IP policy until the new outcome reaches a predetermined threshold of impact.

19. The method as recited in claim 1, wherein the agent receiving the choice of IP policy comprises a DNS agent at a DNS server.

20. The method as recited in claim 1, wherein the agent receiving the choice of IP policy comprises a software application operating on the client.
